(19) United States
(12) Patent Application Publication
(10) Pub. No.: US 2024/0378499 A1
(43) Pub. Date: Nov. 14, 2024

(54) LEARNING APPARATUS, INFERENCE APPARATUS, LEARNING METHOD, AND COMPUTER-READABLE MEDIUM

(71) Applicant: NEC Corporation, Minato-ku, Tokyo (JP)

(72) Inventors: Junki MORI, Tokyo (JP); Isamu TERANISHI, Tokyo (JP); Hikaru TSUCHIDA, Tokyo (JP); Batnyam ENKHTAIVAN, Tokyo (JP); Kunihiro ITO, Tokyo (JP)

(73) Assignee: NEC Corporation, Minato-ku, Tokyo (JP)

(21) Appl. No.: 18/559,389

(22) PCT Filed: May 13, 2021
(86) PCT No.: PCT/JP21/18265

§ 371 Date: Nov. 7, 2023

(51) Int. Cl. G06N 20/00; G06F 21/55

(52) U.S. Cl. CPC G06N 20/00; G06F 21/55; G06F 2221/033

(57) ABSTRACT

A learning apparatus according to the present example embodiment includes: a data dividing unit that generates n sets of divided data by dividing first learning data into n (n is an integer of 2 or more); an inference device generation unit that generates n inference devices for learning data generation by machine learning using data excluding one set of divided data from the first learning data; a learning data generation unit that generates second learning data by inputting the one set of the divided data excluded from the machine learning into each of the n inference devices for learning data generation; and a learning unit that generates a second inference device by machine learning using the second learning data.

### TECHNICAL FIELD

The present disclosure relates to machine learning.

### BACKGROUND ART

Non Patent Literatures 1 and 2 describes a membership inference (MI) attack that leaks confidential information (e.g., client information, confidential corporate information, etc.) used for learning from learned parameters of machine learning. For example, Non Patent Literature 1 discloses a method of MI attack under a condition that an inference algorithm can be accessed. The MI attack is executed by using a phenomenon of “overfitting” of machine learning. The overfitting is a phenomenon in which machine learning is excessively adapted to data used for learning. Due to the overfitting, a tendency of an output when the data used for learning are input to an input of the inference algorithm is different from a tendency of an output when data not used for learning are input thereto. An attacker of the MI attack exploits the difference in this tendency and thereby determines whether data at hand are used for learning.

Non Patent Literature 4 discloses a method called MemGuard. In this method, as a countermeasure against a black box attack under a condition that learned parameters of an inference algorithm of an attack target are not known, processing of causing a classifier of an attacker to misunderstand is performed.

Non Patent Literature 5 discloses a learning algorithm resistant to the MI attack. Specifically, Non Patent Literature 5 uses an inference algorithm f of any known machine learning and a discriminator h that discriminates whether data being input to the f are data used for learning the f. Then, each parameter is learned hostile, and inference accuracy of the inference algorithm f and resistance to the MI attack are raised.

### CITATION LIST

### Non Patent Literature

[Non Patent Literature 1] Reza Shokri, Marco Stronati, Congzheng Song, Vitaly Shmatikov: “Membership Inference Attacks Against Machine Learning Models”, IEEE Symposium on Security and Privacy 2017: pp. 3-18, [online], [searched on Apr. 19, 2021],
Internet <URL:https://arxiv.org/pdf/1610.05820.pdf>

[Non Patent Literature 2] Ahmed Salem, Yang Zhang, Mathias Humbert, Pascal Berrang, Mario Fritz, Michael Backes: “ML-Leaks: Model and Data Independent Membership Inference Attacks and Defenses on Machine Learning Models”, Network and Distributed System Security Symposium 2019, [online], [searched on Apr. 19, 2021], Internet <URL:https://arxiv.org/abs/1806.01246>

[Non Patent Literature 3] L. Song and P. Mittal. “Systematic Evaluation of Privacy Risks of Machine Learning Models”, USENIX Security Symposium 2021, [online], [searched on Apr. 19, 2021],
Internet <URL:https://arxiv.org/abs/2003.10595>

[Non Patent Literature 4] Jinyuan Jia, Ahmed Salem, Michael Backes, Yang Zhang, Neil Zhenqiang Gong, “MemGuard: Defending against Black-Box Membership Inference Attacks via Adversarial Examples”, ACM SIGSAC Conference on Computer and Communications Security 2019: pp. 259-274, [online], [searched on Apr. 19, 2021], Internet
<URL: https://arxiv.org/pdf/1909.10594.pdf>

[Non-Patent Literature 5] Milad Nasr, Reza Shokri, Amir Houmansadr, “Machine Learning with Membership Privacy using Adversarial Regularization”, ACM SIGSAC Conference on Computer and Communications Security 2018: pp. 634-646, [online], [searched on Apr. 19, 2021],
Internet <URL:https://arxiv.org/pdf/1807.05852.pdf>

### SUMMARY OF INVENTION

### Technical Problem

In machine learning, data (also referred to as training data) used for learning may include confidential information such as client information and confidential corporate information. The MI attack may leak confidential information used for learning from learned parameters of machine learning. For example, an attacker who illegally acquires a learned parameter may infer learning data. Alternatively, even when the learned parameter is not leaked, the attacker accesses an inference algorithm many times, thereby enabling to predict the learned parameter. Then, learning data may be predicted from the predicted learned parameters.

In addition, the method of Non Patent Literature 4 performs protection by adding noise to an inference result. Therefore, there is a problem that the inference result is affected by noise regardless of protection performance.

In Non Patent Literature 5, accuracy and attack resistance are traded off. Specifically, a parameter that determines a degree of trade-off between accuracy and attack resistance is set. Therefore, there is a problem that it is difficult to improve both accuracy and attack resistance.

An object of the present disclosure is to provide an inference apparatus, a learning apparatus, a learning method, and a recording medium that are highly resistant to MI attacks and have high accuracy.

### Solution to Problem

A learning apparatus according to the present disclosure includes: a data dividing unit configured to generate n sets of divided data by dividing first learning data into n (n is an integer of 2 or more); an inference device generation unit configured to generate n inference devices for learning data generation by machine learning using data excluding one set of divided data from the first learning data; a learning data generation unit configured to generate second learning data by inputting the one set of the divided data excluded from the machine learning into each of the n inference devices for learning data generation; and a learning unit configured to generate an inference device by machine learning using the second learning data.

A learning method according to the present disclosure includes: generating n sets of divided data by dividing first learning data into n (n is an integer of 2 or more); generating n inference devices for learning data generation by machine learning using data excluding one set of divided data from the first learning data; generating second learning data by inputting the one set of the divided data excluded from the machine learning into each of the n inference devices for learning data generation; and generating an inference device by machine learning using the second learning data.

A computer-readable medium according to the present disclosure is a computer-readable medium storing a program for causing a computer to execute a learning method, and the learning method includes: generating n sets of divided data by dividing first learning data into n (n is an integer of 2 or more); generating n inference devices for learning data generation by machine learning using data excluding one set of divided data from the first learning data; and generating second learning data by inputting the one set of the divided data excluded from the machine learning into each of the n inference devices for learning data generation; and generating an inference device by machine learning using the second learning data.

### Advantageous Effects of Invention

According to the present disclosure, it is possible to provide a learning apparatus, an inference apparatus, a learning method, and a computer-readable medium that are highly resistant to MI attacks and highly accurate.

### BRIEF DESCRIPTION OF DRAWINGS

FIG. 1 is a block diagram illustrating a configuration of a machine learning system including a learning apparatus;

FIG. 2 is a flowchart illustrating an operation of the learning apparatus;

FIG. 3 is a flowchart illustrating an operation of a learning unit of an inference device H;

FIG. 4 is a block diagram illustrating an operation of a learning apparatus according to another example embodiment; and

FIG. 5 is a diagram illustrating a hardware configuration of the apparatus according to the present example embodiment.

### EXAMPLE EMBODIMENT

### First Example Embodiment

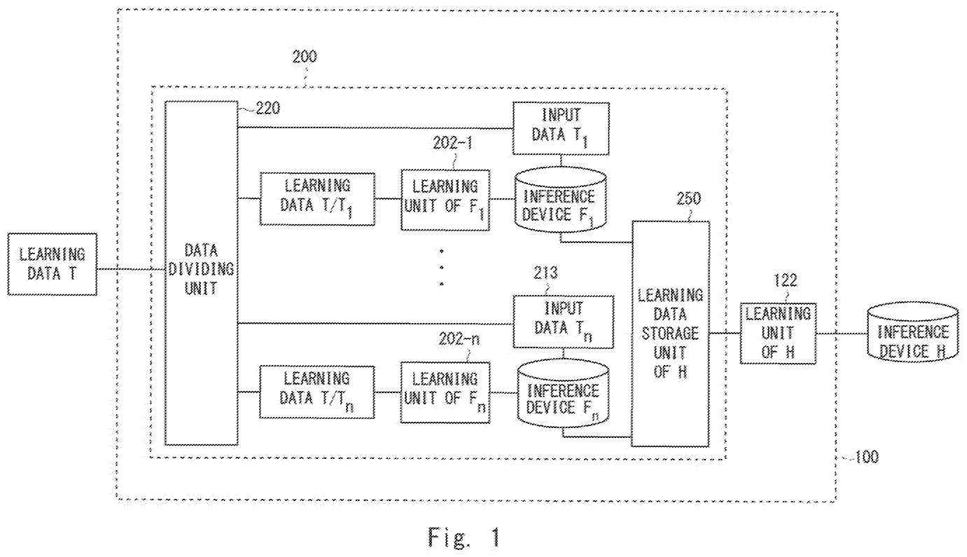

A machine learning (training) according to the present example embodiment will be explained with reference to FIG. 1. FIG. 1 is a block diagram illustrating a configuration of a machine learning system including a learning apparatus 100. The learning apparatus 100 includes a data generation unit 200 and a learning unit 122. In machine learning of an inference device H, learning data T are prepared in advance. The learning data T are also referred to as member data, and data other than the learning data T are also referred to as non-member data.

The data generation unit 200 generates learning data of the inference device H, based on the learning data T. Hereinafter, the learning data T prepared in advance are also referred to as first learning data, and the learning data generated by the data generation unit 200 are also referred to as second learning data. The learning unit 122 performs machine learning, based on the second learning data generated by the data generation unit 200. In this way, the inference device H is generated.

The inference device H is a machine learning model that performs inference on input data. In short, the inference device H outputs an inference result when the inference device H performs the inference based on the input data. For example, the inference device H may be a classifier that performs image classification. In this case, the inference device H outputs a score vector indicating a probability of falling under each class.

The learning data T are the first learning data, and are a data group including a plurality of pieces of data. When supervised learning is performed, the learning data T become a data set with correct answer labels (teacher data). The learning data T include a plurality of pieces of input data, and a correct answer label is associated with each piece of input data. Of course, machine learning is not limited to supervised learning.

The data generation unit 200 generates second learning data (training data) used for machine learning of the inference device H. The data generation unit 200 includes a data division unit 220, learning units 202-1 to 202-n of F₁ to Fₙ, and a learning data storage unit 250.

The data dividing unit 220 divides the learning data T into n (n is an integer of 2 or more). Herein, the n-divided learning data are assumed to be divided data T₁ to Tₙ. In short, the data dividing unit 220 generates n sets of the divided data T₁ to Tₙ by dividing the learning data T into n. When the learning data T are one data set, each piece of the divided data T₁ to Tₙ becomes a subset. As will be described later, the divided data T₁ to Tₙ become input data of the inference devices F₁ to Fₙ, respectively.

It is preferable that the data sets included in the divided data T₁ to Tₙ do not overlap with each other. For example, it is preferable that data included in the divided data T₁ are not included in the divided data T₂ to Tₙ. Further, it is preferable that data included in the divided data Tₙ are not included in divided data T₁ to Tₙ₋₁.

It is preferable that the number of pieces of data included in the divided data T₁ to Tₙ be equal. In short, the data dividing unit 220 divides the learning data T into n pieces equally. Therefore, the divided data T₁ to Tₙ include the same number of pieces of data. The number of pieces of data included in the divided data T₁ to Tₙ is not limited to being equal, and may be different. The data dividing unit 220 outputs a part of divided data extracted from the learning data T to the learning units 202-1 to 202-n.

The data generation unit 200 extracts learning data Tn¥T₁ from the divided data T₁ to Tₙ, and inputs the extracted learning data T₁ to the learning unit 202-1 of the F₁. Note that the learning data T¥T₁ become a set of differences acquired by excluding the divided data T₁ from the learning data T. In short, the learning data T¥T₁ of the F₁ include T₂ to Tₙ. The data generation unit 200 generates the learning data T¥T₁ by removing the divided data T₁ from the learning data T.

The learning unit 202-1 of the F₁ performs machine learning for generating the inference device F₁ using the learning data T¥T₁. The learning unit 202-1 trains the inference device F₁, based on the learning data T¥T₁. As for the machine learning in the learning unit 202-1, various methods such as supervised learning can be used. Since a known method can be used for the machine learning of the learning unit 202-1, an explanation thereof will be omitted. The learning unit 202-1 performs machine learning using all data included in the learning data T¥T₁. In the machine learning, for example, parameters of each layer in a deep learning model are optimized. As a result, the inference device F₁ is generated.

The data generation unit 200 inputs the divided data T₁ to the inference device F₁. The learning data storage unit 250 of the inference device H stores an output of the inference device F₁ as the learning data of the H. In short, an inference result of the inference device F₁ is stored in a memory or the like as the learning data of the inference device H. The learning data of the inference device H include the inference result of the inference device F₁ when the divided data T₁ are input to the inference device F₁. As described above, the learning data used when the inference device F₁ is learned differs from input data used when the inference is performed.

The learning unit 202-n of the Fₙ performs machine learning for generating the inference device Fₙ using the learning data T¥Tₙ. The learning unit 202-n trains the inference device Fₙ, based on the learning data T¥Tₙ. As for machine learning in the learning unit 202-n, various methods such as supervised learning can be used. A well-known method can be used for the machine learning of the learning unit 202-n, and thus an explanation thereof will be omitted. The learning unit 202-n performs machine learning by using all data included in the learning data T¥Tₙ. In the machine learning, for example, parameters of each layer in the deep learning model are optimized. As a result, the inference device Fₙ is generated.

The data generation unit 200 inputs the divided data Tₙ to the inference device Fₙ. The learning data storage unit 250 of the inference device H stores an output of the inference device Fₙ as the learning data of the H. In short, an inference result of the inference device Fₙ is stored in a memory or the like as the learning data of the inference device H. The learning data of the inference device H include the inference result of the inference device Fₙ when the divided data Tₙ are input to the inference device Fₙ. As described above, the learning data used when the inference device Fₙ is learned differs from the input data used when the inference is performed.

Note that when i (i is any integer from 1 or more to n or less) is used and the machine learning in the inference devices F₁ to Fₙ is generalized, the following results are acquired. The data generation unit 200 receives the entire set of the learning data T. The data dividing unit 220 divides the learning data T into n sets (n subsets) and generates divided data Tᵢ. The learning unit of the data generation unit 200 performs machine learning on an inference device Fᵢ by using the learning data T¥Tᵢ. Learning data used for the machine learning of the inference device Fᵢ become T₁ to Tᵢ₋₁, and Tᵢ₊₁ to Tₙ. The inference device Fᵢ performs inference, based on the divided data Tᵢ. The learning data storage unit 250 stores an inference result of the inference device Fᵢ as learning data.

As described above, the inference devices F₁ to Fₙ serve as the learning data generation unit that generates the second learning data. The learning units 202-1 to 202-n of the F₁ to Fₙ serve as an inference device generation unit for learning data generation, which generates the inference devices F₁ to Fₙ. Note that the inference devices F₁ to Fₙ can be machine-learning models having the same layer configuration. In short, the number of layers, nodes, edges, and the like of the inference devices F₁ to Fₙ are the same. Then, the learning units 202-1 to 202-n generate the inference devices F₁ to Fₙ by using different learning data. In short, the inference devices F₁ to Fₙ are machine learning models that are generated by using different learning data. Similarly to the inference device H, the inference devices F₁ to Fₙ are machine-learning models for performing image classification and the like. In this case, the inference devices F₁ to Fₙ output the same score vector as the inference device H.

The learning data storage unit 250 of the inference device H stores inference results of the inference devices F₁, F₂, . . . , Fᵢ, . . . , Fₙ₋₁, and Fₙ as learning data. The learning data storage unit 250 may store the input data to the inference devices F₁ to Fₙ and the inference result thereof in association with each other. As described above, the learning data stored in the learning data storage unit 250 of the inference device H become the second learning data. Therefore, in the following explanation, the learning data stored in the learning data storage unit 250 of the inference device H are also simply referred to as second learning data. The second learning data become a data set represented by the following equation (1).

$$[ Mathematical 1 ]$$

$${{⋃}^{n}}_{i = 1} \{ ( x , {F}_{i} ( x ) ) \vert x ∈ {T}_{i} \} \qquad ( 1 )$$

The learning unit 122 of the inference device H performs machine learning for generating the inference device H by using the second learning data. The learning unit 122 trains the inference device H, based on the second learning data. As the machine learning in the learning unit 122, various methods such as supervised learning can be used. Since a known method can be used for the machine learning of the learning unit 122, an explanation thereof will be omitted. The learning unit 122 performs machine learning by using all the data included in the second learning data. In the machine learning, for example, parameters of each layer in the deep learning model are optimized. In this way, the inference device H is generated.

For example, the learning unit 122 performs supervised learning by using an inference result Fᵢ(x) of input data x included in the divided data Tᵢ as a correct answer label. When the input data x are input to the inference device H, the inference result being output from the inference device H is represented by the following equation (2).

$$[ Mathematical 2 ]$$

$$H ( x ) = {F}_{i} ( x ) , x ∈ {T}_{i} \qquad ( 2 )$$

As described above, in the present example embodiment, the data generation unit 200 generates the learning data of the inference device H, based on outputs of the inference devices F₁ to Fₙ. The inference device H becomes a distillation model generated by using the outputs of the inference devices F₁ to Fₙ. In short, the inference devices F₁ to Fₙ extract some pieces of information from the learning data T. The learning data storage unit 250 learns the inference device H by using the information extracted by the inference devices F₁ to Fₙ as learning data. Therefore, the inference device H can acquire high estimation accuracy with a simple model.

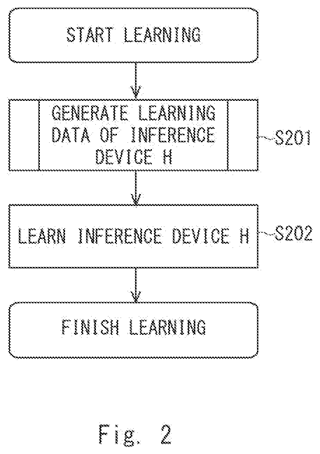

Hereinafter, a learning method according to the present example embodiment will be explained with reference to FIG. 2. FIG. 2 is a flowchart illustrating a learning method according to the present example embodiment.

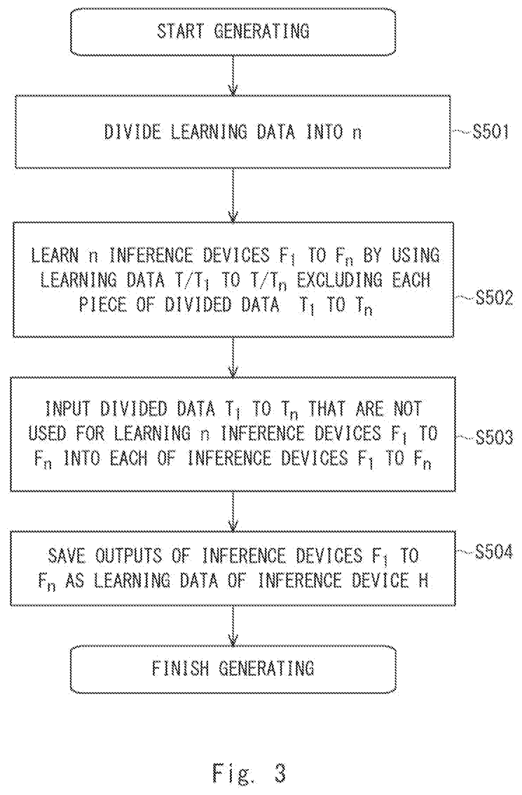

First, the data generation unit 200 generates learning data of the inference device H (S201). Processing of step S201 will be explained in detail with reference to FIG. 3. FIG. 3 is a flowchart illustrating the processing of generating learning data of the inference device H.

The data dividing unit 220 divides the learning data T by n (S501). In short, the data dividing unit 220 generates divided data T₁ to Tₙ. The learning units 202-1 to 202-n cause the n inference devices F₁ to Fₙ to be learned by the learning data excluding the divided data T₁ to Tₙ (S502). In short, the learning unit of the data generation unit 200 performs machine learning on the inference device Fᵢ by using the T¥Tᵢ.

The data generation unit 200 inputs divided data that have not been used for learning the n inference devices F₁ to Fₙ to each of the inference devices F₁ to Fₙ (S503). In short, the data generation unit 200 inputs the divided data Tᵢ to the inference device Fᵢ. In other words, the divided data Tᵢ are input to the inference device Fᵢ in such a way that the input data at the time of learning of the inference device Fᵢ and the input data at the time of inference of the inference device Fᵢ differ from each other. For example, the divided data Tᵢ excluded by the machine learning in the learning unit 202-1 of the Fᵢ are input to the inference device Fᵢ.

The learning data storage unit 250 stores the outputs of the inference devices F₁ to Fₙ as learning data of the inference device H (S504). In short, the inference device Fᵢ performs inference, based on the divided data Tᵢ excluded from the machine learning that generates the inference device Fᵢ. The learning data storage unit 250 stores the inference result of the inference device Fᵢ as the learning data of the inference device H. As a result, the generation of the learning data is completed.

The explanation of FIG. 2 is returned. The learning unit 122 learns the inference device H by using the second learning data (S202). The learning unit 122 reads the learning data stored in the learning data storage unit 250 and uses it for the machine learning of the inference device H. Thus, the inference device H is generated. In this way, the data generation unit 200 generates the inference device H.

By doing so, it is possible to generate the inference device H having high resistance to the MI attack and high accuracy. In short, when the data included in the learning data T are input to the inference device H as the input data, the inference device Fᵢ generated by machine learning excluding the input data performs inference. Therefore, sufficient safety can be acquired only by the inference device H.

The inference device H lowers classification accuracy for the member data to classification accuracy for the non-member data. Therefore, higher safety can be acquired. Further, the learning unit 122 performs supervised learning using the inference result acquired by the inference device Fᵢ as a correct answer label. When the member data are input to the inference device H, the inference result of the inference device Fᵢ learned by the non-member data excluding the member data is output. Therefore, sufficient safety can be acquired by the inference device H alone.

In the present example embodiment, the data generation unit 200 generates the learning data of the inference device H, based on the outputs of the inference devices F₁ to Fₙ. The inference device H is a distillation model generated by using the outputs of the inference devices F₁ to Fₙ. In short, the inference devices F₁ to Fₙ extract some pieces of information from the learning data T. The learning data storage unit 250 learns the inference device H by using the information extracted by the inference devices F₁ to Fₙ as learning data. Therefore, the inference device H can acquire high accuracy with a simple model.

### Modified Example

In a modified example, the learning unit 122 uses not only the second learning data but also the first learning data. In short, the learning unit 122 performs machine learning by using at least a part of the learning data T. In the learning data T, a true correct answer label y for the input data x is associated with each other. In the modified example, the learning unit 122 can adjust a ratio of the true correct answer label y to be mixed with the second learning data.

Herein, the second learning data are a data set represented by the equation (1). Let L₀ denote a loss-function when learning is performed by using the data set represented by the above equation (1). Let L₁ denote a loss-function when learning is performed by using the learning data T that are the first learning data. Also, let α denote a parameter for adjusting the safety and accuracy against MI attack. α is a real number equal to or greater than 0 and equal to or less than 1.

For example, the parameter α indicates a ratio of the first learning data to the second learning data. The learning unit 122 generates the inference device H, based on the parameter α, the loss function L₁, and the loss function L₀. For example, the learning unit 122 calculates the loss function L_{α} represented by the following equation (3).

$${L}_{α} = ( 1 - α ) {L}_{0} + α L 1 \qquad ( 3 )$$

The learning unit 122 performs machine learning, based on the loss-function L_{α}. The learning unit 122 performs machine learning in such a way as to reduce the loss-function L_{α}. When a is large, the safety is lowered, but the accuracy is improved. When α=1, the loss-function L₀ is not taken into account, and therefore, it is the same as the conventional learning. When the value of α is small, the accuracy is lowered, but the safety is improved. When α=0, the learning is the same as that of the inference device H of the first example embodiment. Therefore, when it is desired to increase the accuracy of the inference device H, the user increases the value of α. When it is desired to increase the safety of the inference device H, the user decreases the value of α. As described above, by introducing the parameter a into the machine learning of the learning unit 122, it is possible to easily adjust the safety and the accuracy.

### Another Example Embodiment

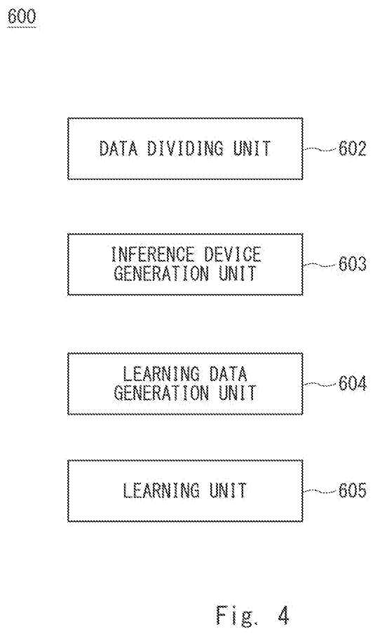

FIG. 4 is a block diagram illustrating a learning apparatus 600 according to another example embodiment. The learning apparatus 600 includes a data dividing unit 602, an inference device generation unit 603, a learning data generation unit 604, and a learning unit 605.

The data dividing unit 602 generates n sets of divided data by dividing first learning data into n (n is an integer of 2 or more). The inference device generation unit 603 generates n inference devices for learning data generation by machine learning using data acquired by excluding one set of divided data from the first learning data. The learning data generation unit 604 generates second learning data by inputting the one set of the divided data excluded from the machine learning to the n inference devices for learning data generation. The learning unit 605 generates an inference device by machine learning using the second learning data. This makes it possible to achieve a machine learning model that is highly resistant to MI attacks and highly accurate.

In the above example embodiments, each element of the machine learning system can be achieved by a computer program. In short, each of the inference device H, the learning unit 122, the data generation unit 200, and the like can be achieved by a computer program. Further, the inference device H, the learning unit 122, the data generation unit 200, and the like may not be physically a single apparatus, and may be distributed among a plurality of computers.

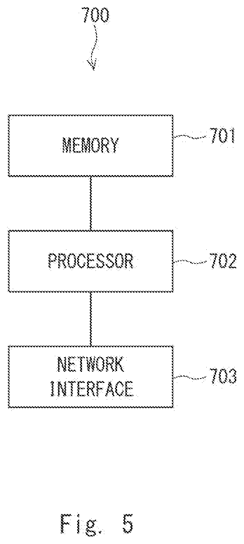

Next, a hardware configuration of the machine learning system according to the example embodiment will be explained. FIG. 5 is a block diagram illustrating one example of a hardware configuration of a machine learning system 700. As illustrated in FIG. 5, the machine learning system 700 includes, for example, at least one memory 701, at least one processor 702, and a network interface 703.

The network interface 703 is used for communicating with other apparatuses via a wired or wireless network. The network interface 703 may include, for example, a network interface card (NIC). The machine learning system 700 transmits and receives data via the network interface 703. The machine learning system 700 may acquire the learning data T via the network interface.

The memory 701 includes a combination of a volatile memory and a non-volatile memory. The memory 701 may include a storage located remotely from the processor 702. In this case, the processor 702 may access the memory 701 via an input/output interface that is not illustrated.

The memory 701 is used for storing software (computer program) and the like including one or more instructions to be executed by the processor 702. When the machine learning system 700 includes the learning apparatus 100, the memory 701 may store the inference device H, the learning units 121 to 123, the data generation unit 200, and the like.

The program includes an instruction group (or software code) that, when loaded into a computer, causes the computer to perform one or more of the functions explained in the example embodiments. The program may be stored in a non-transitory computer-readable medium or a tangible storage medium. By way of example, and not limitation, the computer-readable media or tangible storage media include random-access memory (RAM), read-only memory (ROM), flash memory, solid-state drive (SSD) or other memory techniques, CD-ROM, digital versatile disc (DVD), Blu-ray (registered trademark) disk or other optical disk storage, magnetic cassettes, magnetic tape, magnetic disk storage or other magnetic storage devices. The program may be transmitted on a transitory computer-readable medium or a communication medium. By way of example, and not limitation, the transitory computer-readable media or communication media include electrical, optical, acoustic, or other forms of propagated signals.

Some or all of the above-described example embodiments may be described as the following supplementary notes, but are not limited thereto.

### Supplementary Note 1

A learning apparatus comprising:
a data dividing unit configured to generate n sets of divided data by dividing first learning data into n (n is an integer of 2 or more);
an inference device generation unit configured to generate n inference devices for learning data generation by machine learning using data excluding one set of divided data from the first learning data;
a learning data generation unit configured to generate second learning data by inputting the one set of the divided data excluded from the machine learning into each of the n inference devices for learning data generation; and
a learning unit configured to generate an inference device by machine learning using the second learning data.

### Supplementary Note 2

The learning apparatus according to supplementary note 1, wherein the learning unit generates the inference device by machine learning using the first learning data.

### Supplementary Note 3

The learning apparatus according to supplementary note 2, wherein,
in the first learning data, input data and a correct answer label are associated with each other, and,
in machine learning of the learning unit, a ratio of the first learning data to the second learning data is set.

### Supplementary Note 4

The learning apparatus according to supplementary note 3, wherein the learning unit generates the inference device, based on a parameter α, a loss function L₁, and a loss function L₀ when α is a parameter indicating a ratio of the first learning data to the second learning data, L₁ is a loss function in machine learning with the first learning data, and L₀ is a loss function in machine learning with the second learning data.

### Supplementary Note 5

The learning apparatus according to supplementary note 3, wherein the learning unit calculates a loss function L_{α}, based on a following equation (3),

$${L}_{α} = ( 1 - α ) {L}_{0} + α {L}_{1} , \qquad ( 3 )$$

calculates the inference device, based on the loss function L_{α}.

### Supplementary Note 6

An inference apparatus being generated by the learning apparatus according to any one of supplementary notes 1 to 5.

### Supplementary Note 7

A learning method comprising:
generating n sets of divided data by dividing first learning data into n (n is an integer of 2 or more);
generating n inference devices for learning data generation by machine learning using data excluding one set of divided data from the first learning data;
generating second learning data by inputting the one set of the divided data excluded from the machine learning into each of the n inference devices for learning data generation; and
generating an inference device by machine learning using the second learning data.

### Supplementary Note 8

The learning method according to supplementary note 7, further comprising generating the inference device by machine learning using the first learning data.

### Supplementary Note 9

The learning method according to supplementary note 8, wherein,
in the first learning data, input data and a correct answer label are associated with each other and
a ratio of the first learning data to the second learning data is set in machine learning of the learning unit.

### Supplementary Note 10

The learning method according to supplementary note 9, wherein the learning unit generates the inference device, based on a parameter α, a loss function L₁, and a loss function L₀ when α is a parameter indicating a ratio of the first learning data to the second learning data, L₁ is a loss function in machine learning with the first learning data, and L₀ is a loss function in machine learning with the second learning data.

### Supplementary Note 11

The learning method according to supplementary note 10, wherein a loss function L_{α} is calculated based on a following equation (3),

$${L}_{α} = ( 1 - α ) {L}_{0} + α {L}_{1} , \qquad ( 3 )$$

and
calculates the inference device, based on the loss function L_{α}.

### Supplementary Note 12

A computer-readable medium storing a program for causing a computer to execute a learning method, the learning method including:
generating n sets of divided data by dividing first learning data into n (n is an integer of 2 or more);
generating n inference devices for learning data generation by machine learning using data excluding one set of divided data from the first learning data;
generating second learning data by inputting the one set of the divided data excluded from the machine learning into each of the n inference devices for learning data generation; and
generating an inference device by machine learning using the second learning data.

### Supplementary Note 13

The computer-readable medium according to supplementary note 12, wherein the learning method further includes generating the inference device by machine learning using the first learning data.

### Supplementary Note 14

The computer-readable medium according to supplementary note 13, wherein,
in the first learning data, input data and a correct answer label are associated with each other, and
in machine learning of the learning unit, a ratio of the first learning data to the second learning data is set.

### Supplementary Note 15

The computer-readable medium according to supplementary note 14, wherein the learning unit generates the inference device, based on a parameter α, a loss function L₁, and a loss function L₀ when α is a parameter indicating a ratio of the first learning data to the second learning data, L₁ is a loss function in machine learning with the first learning data, and L₀ is a loss function in machine learning with the second learning data.

### Supplementary Note 16

The computer-readable medium according to supplementary note 15, wherein the learning unit calculates a loss function L_{α}, based on a following equation (3),

$${L}_{α} = ( 1 - α ) {L}_{0} + α {L}_{1} , \qquad ( 3 )$$

and
calculates the inference device, based on the loss function L_{α}.

The present disclosure is not limited to the above-described example embodiments, and can be appropriately modified without departing from the scope of the present disclosure.

### REFERENCE SIGNS LIST

T LEARNING DATA

T₁ to Tₙ DIVIDED DATA

121 LEARNING UNIT

122 LEARNING UNIT

123 LEARNING UNIT

200 DATA GENERATION UNIT

220 DATA DIVIDING UNIT

202-1 LEARNING UNIT OF F₁

202-n LEARNING UNIT OF Fₙ

250 LEARNING DATA STORAGE UNIT

F₁ INFERENCE DEVICE

Fₙ INFERENCE DEVICE

H INFERENCE DEVICE

What is claimed is:

1.-10. (canceled)

11. A learning apparatus comprising:
at least one processor and
at least one memory storing instructions executable by the processor,
the processor configured to
generate n sets of divided data by dividing first learning data into n (n is an integer of 2 or more);
generate n inference devices for learning data generation by machine learning using data excluding one set of divided data from the first learning data;
generate second learning data by inputting the one set of the divided data excluded from the machine learning into each of the n inference devices for learning data generation; and
generate an inference device by machine learning using the second learning data.

12. The learning apparatus according to claim 11, wherein the processor generates the inference device by machine learning using the first learning data.

13. The learning apparatus according to claim 12, wherein,
in the first learning data, input data and a correct answer label are associated with each other, and,
in machine learning, a ratio of the first learning data to the second learning data is set.

14. The learning apparatus according to claim 13, wherein the processor generates the inference device, based on a parameter α, a loss function L₁, and a loss function L₀ when α is a parameter indicating a ratio of the first learning data to the second learning data, L₁ is a loss function in machine learning with the first learning data, and L₀ is a loss function in machine learning with the second learning data.

15. The learning apparatus according to claim 14, wherein the processor calculates a loss function L_{α}, based on a following equation (3),
$${L}_{α} = ( 1 - α ) {L}_{0} + α {L}_{1} , \qquad ( 3 )$$
calculates the inference device, based on the loss function L₆₀.

16. An inference apparatus being generated by the learning apparatus according to claim 11.

17. A learning method comprising:
generating n sets of divided data by dividing first learning data into n (n is an integer of 2 or more);
generating n inference devices for learning data generation by machine learning using data excluding one set of divided data from the first learning data;
generating second learning data by inputting the one set of the divided data excluded from the machine learning into each of the n inference devices for learning data generation; and
generating an inference device by machine learning using the second learning data.

18. The learning method according to claim 17, further comprising generating the inference device by machine learning using the first learning data.

19. The learning method according to claim 18, wherein,
in the first learning data, input data and a correct answer label are associated with each other and
a ratio of the first learning data to the second learning data is set in machine learning.

20. The learning method according to claim 19, wherein the inference device is generated based on a parameter α, a loss function L₁, and a loss function L₀ when α is a parameter indicating a ratio of the first learning data to the second learning data, L₁ is a loss function in machine learning with the first learning data, and L₀ is a loss function in machine learning with the second learning data.

21. The learning method according to claim 19, wherein a loss function L₆₀ is calculated based on a following equation (3),
$${L}_{α} = ( 1 - α ) {L}_{0} + α {L}_{1} , \qquad ( 3 )$$
and
the inference device is calculated based on the loss function L₆₀.

22. A non-transitory computer-readable medium storing a program for causing a computer to execute a learning method, the learning method including:
generating n sets of divided data by dividing first learning data into n (n is an integer of 2 or more);
generating n inference devices for learning data generation by machine learning using data excluding one set of divided data from the first learning data;
generating second learning data by inputting the one set of the divided data excluded from the machine learning into each of the n inference devices for learning data generation; and
generating an inference device by machine learning using the second learning data.

23. The non-transitory computer-readable medium according to claim 22, wherein the learning method further includes generating the inference device by machine learning using the first learning data.

24. The non-transitory computer-readable medium according to claim 23, wherein,
in the first learning data, input data and a correct answer label are associated with each other, and
in machine learning, a ratio of the first learning data to the second learning data is set.

25. The non-transitory computer-readable medium according to claim 24, wherein the inference device is generated based on a parameter α, a loss function L₁, and a loss function L₀ when α is a parameter indicating a ratio of the first learning data to the second learning data, L₁ is a loss function in machine learning with the first learning data, and L₀ is a loss function in machine learning with the second learning data.

26. The non-transitory computer-readable medium according to claim 25, wherein a loss function L₆₀, is calculated based on a following equation (3),
$${L}_{α} = ( 1 - α ) {L}_{0} + α {L}_{1} , \qquad ( 3 )$$
the inference device is calculated based on the loss function L_{α}.
